(19) United States
(12) Patent Application Publication
(10) Pub. No.: US 2013/0067451 A1
(43) Pub. Date: Mar. 14, 2013

(54) APPLICATION DEPLOYMENT AND REGISTRATION IN A MULTI-USER SYSTEM

(71) Applicants: Amjad Hussain, Kirkland, WA (US); Huei Chung Wang, Kirkland, WA (US); Ashish Awasthi, San Jose, CA (US); Hemchander V. Sannidhanam, Bothell, WA (US); Andrey Vladimirowich Eremenko, Redmond, WA (US)

(72) Inventors: Amjad Hussain, Kirkland, WA (US); Huei Chung Wang, Kirkland, WA (US); Ashish Awasthi, San Jose, CA (US); Hemchander V. Sannidhanam, Bothell, WA (US); Andrey Vladimirowich Eremenko, Redmond, WA (US)

(73) Assignee: MICROSOFT CORPORATION, Redmond, WA (US)

(21) Appl. No.: 13/327,707

(22) Filed: Dec. 15, 2011

Related U.S. Application Data
(60) Provisional application No. 61/533,749, filed on Sep. 12, 2011.

(51) Int. Cl. G06F 9/445

(52) U.S. Cl. 717/172; 717/177

(57) ABSTRACT

Embodiments are directed to efficiently provisioning applications in a multi-user environment. In one scenario, an administrator computer system pre-installs at least a portion of a software application on a data image, where the software application is to be installed on a client computer system upon receiving a notification from a computer administrator. The administrator computer system receives an input from the computer administrator indicating that a specified software application pre-installed on the client computer system's data image is to be installed on the client computer system. The administrator computer system then publishes a notification to the client computer system indicating that a specified software application pre-installed on the client computer system's data image is to be installed. Upon receiving the notification, the software application is installed on the client computer system from the data image.

### CROSS-REFERENCE TO RELATED APPLICATIONS

This application claims the benefit of and priority to U.S. Provisional Application No. 61/533,749, entitled “MECHANISM FOR APPLICATION DEPLOYMENT AND REGISTRATION IN A MULTI-USER SYSTEM”, filed on Sep. 12, 2011, which is incorporated by reference in its entirety herein.

### BACKGROUND

Computers have become highly integrated in the workforce, in the home, in mobile devices, and many other places. Computers can process massive amounts of information quickly and efficiently. Software applications designed to run on computer systems allow users to perform a wide variety of functions including business applications, schoolwork, entertainment and more. Software applications are often designed to perform specific tasks, such as word processor applications for drafting documents, or email programs for sending, receiving and organizing email.

In some cases, software applications are provisioned on different computer systems for different users. For example, in a corporate environment, a computer administrator may specify that certain applications are to be installed on a user's computer system when that user logs in. However, such systems require that a central distribution point be established on a network computer system. If that network computer system is not available when the user logs in for the first time, the application(s) will not be installed, and the user will be left without their assigned applications.

### BRIEF SUMMARY

Embodiments described herein are directed to efficiently provisioning applications in a multi-user environment. In one embodiment, an administrator computer system pre-installs at least a portion of a software application on a data image, where the software application is to be installed on a client computer system upon receiving a notification from a computer administrator. The administrator computer system receives an input from the computer administrator indicating that a specified software application pre-installed on the client computer system's data image is to be installed on the client computer system. The administrator computer system then publishes a notification to the client computer system indicating that a specified software application pre-installed on the client computer system's data image is to be installed. Upon receiving the notification, the software application is installed on the client computer system from the data image.

In another embodiment, a client computer system accesses a data image that includes various preinstalled software applications. The client computer system installs those software applications that are preinstalled in the data image. The client computer system then receives login credentials from a user logging in to the client computer system and, based on the user's login credentials, applies user-specific software application registration information and customizations to one or more of the installed software applications.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments of the invention may be realized and obtained by means of the instruments and combinations particularly pointed out in the appended claims. Features of the embodiments of the present invention will become more fully apparent from the following description and appended claims, or may be learned by the practice of the invention as set forth hereinafter.

### BRIEF DESCRIPTION OF THE DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The embodiments of the invention will be described and explained with additional specificity and detail through the use of the accompanying drawings in which:

FIG. 1 illustrates a computer architecture in which embodiments of the present invention may operate including efficiently provisioning applications in a multi-user environment.

FIG. 2 illustrates a flowchart of an example method for efficiently provisioning applications in a multi-user environment.

FIG. 3 illustrates a flowchart of an alternative example method for efficiently provisioning applications in a multi-user environment.

FIG. 4 illustrates an embodiment in which applications are added, updated or removed.

### DETAILED DESCRIPTION

Embodiments described herein are directed to efficiently provisioning applications in a multi-user environment. In one embodiment, an administrator computer system pre-installs at least a portion of a software application on a data image, where the software application is to be installed on a client computer system upon receiving a notification from a computer administrator. The administrator computer system receives an input from the computer administrator indicating that a specified software application pre-installed on the client computer system's data image is to be installed on the client computer system. The administrator computer system then publishes a notification to the client computer system indicating that a specified software application pre-installed on the client computer system's data image is to be installed. Upon receiving the notification, the software application is installed on the client computer system from the data image.

In another embodiment, a client computer system accesses a data image that includes various preinstalled software applications. The client computer system installs those software applications that are preinstalled in the data image. The client computer system then receives login credentials from a user logging in to the client computer system and, based on the user's login credentials, applies user-specific software application registration information and customizations to one or more of the installed software applications.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions in the form of data are computer storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM, solid state drives (SSDs) that are based on RAM, Flash memory, phase-change memory (PCM), or other types of memory, or other optical disk storage, magnetic disk storage or other magnetic storage devices, or any other medium which can be used to store desired program code means in the form of computer-executable instructions, data or data structures and which can be accessed by a general purpose or special purpose computer.

A “network” is defined as one or more data links and/or data switches that enable the transport of electronic data between computer systems and/or modules and/or other electronic devices. When information is transferred or provided over a network (either hardwired, wireless, or a combination of hardwired or wireless) to a computer, the computer properly views the connection as a transmission medium. Transmissions media can include a network which can be used to carry data or desired program code means in the form of computer-executable instructions or in the form of data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”), and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems that are linked (either by hardwired data links, wireless data links, or by a combination of hardwired and wireless data links) through a network, each perform tasks (e.g. cloud computing, cloud services and the like). In a distributed system environment, program modules may be located in both local and remote memory storage devices.

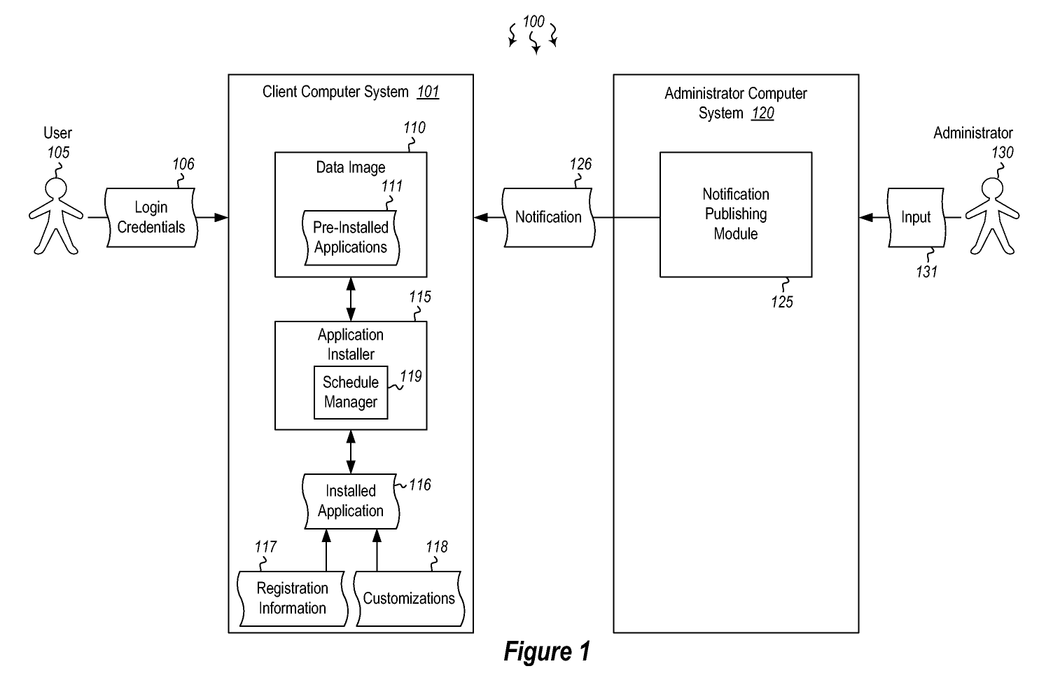

FIG. 1 illustrates a computer architecture 100 in which the principles of the present invention may be employed. Computer architecture 100 includes client computer system 101. Client computer system 101 may be any type of local or distributed computer system including a cloud computing system. The client computer system may include various different modules for performing different portions of desired functionality. The computer architecture also includes an administrative computer system 120. The administrative computer may similarly be any type of local or distributed computer system. In some cases, the administrator computer system may be used solely by a computer administrator. In other cases, the administrator may simply be a computer system where an administrator has logged in. This is likewise true for the client computer system.

In general, embodiments herein describe providing a data-driven, flexible and performant method and system for enabling applications that are inherently per-user to be available in a multi-user environment. A notification mechanism (e.g. notification publishing module 125) may be provided for the application framework to notify a scheduler (e.g. 119) that a change in state has occurred. This notification triggers the scheduler to build a list of users who are currently logged into the computer system (e.g. computer system 101). Then, depending on applicable policy, the administrator computer system publishes the application for the user 105. For new users, the scheduler performs various deployment operations to make the application available to them. A similar approach may be deployed for the updating or removal of applications.

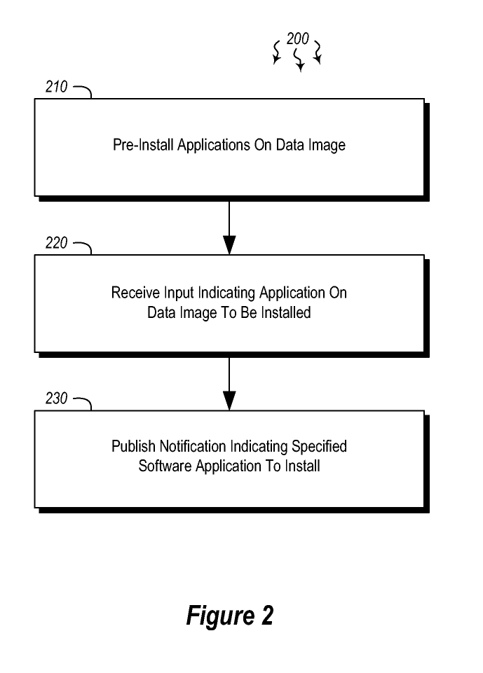

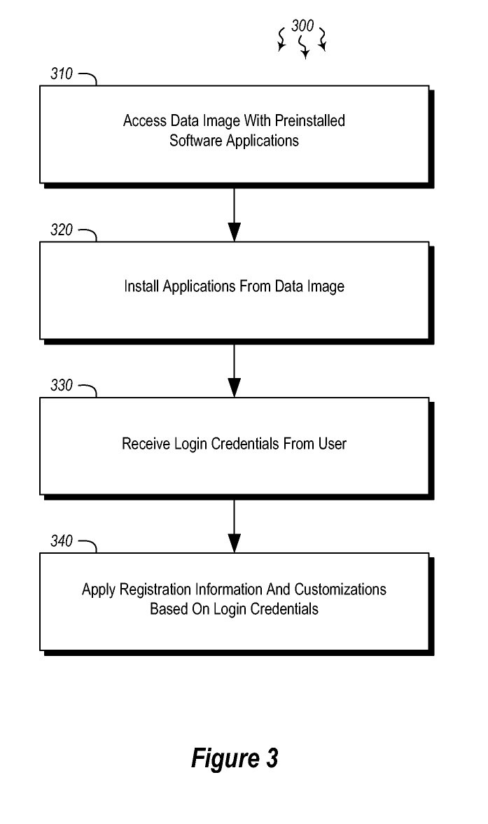

As mentioned above, embodiments allow administrators of a multi-user environment to publish applications that are made available to all-users for a given computer system (e.g. 101). One embodiment may include a schedule manager 119 that is responsible for maintaining per-user state and dispatching commands to perform operations in a performant way for these users (or sessions). The embodiment may also include a per-user scheduler that can identify operations to be performed for a given user (e.g. 105), an optimizer that prevents operations from being performed if administrator has not changed machine state since the last logon for a given user. The embodiment may also include a data driven library that abstracts out application-deployment-specific internal details to keep the framework itself generic, and a lightweight notification framework that notifies the master scheduler that there are changes that need to be picked up. This embodiment, as well as other embodiments and characteristics will be described further below with regard to methods 200 and 300 of FIGS. 2 and 3, respectively.

In view of the systems and architectures described above, methodologies that may be implemented in accordance with the disclosed subject matter will be better appreciated with reference to the flow charts of FIGS. 2 and 3. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 2 illustrates a flowchart of a method 200 for efficiently provisioning applications in a multi-user environment. The method 200 will now be described with frequent reference to the components and data of environment 100.

Method 200 includes an act of pre-installing at least a portion of a software application on a data image, wherein the software application is to be installed on a client computer system upon receiving a notification from a computer administrator (act 210). For example, pre-installed applications 111 may be pre-installed on data image 110. The data image may include a plurality of different pre-installed application images. The pre-installed applications may include all or part of an application. Each application may be pre-installed in the data image in order to be installed on the client computer system 101. The pre-installed applications may be installed upon receiving a notification 126 from an administrator indicating that the application is to be installed. For instance, the notification may be received over a computer network from administrator computer system 120. In some embodiments, the pre-installed applications 111 may be provisioned onto an offline data image that will later be used to install the application on the client computer.

Method 200 includes an act of receiving an input from the computer administrator indicating that a specified software application pre-installed on the client computer system's data image is to be installed on the client computer system (act 220). The indication 131 may be provided by an administrative user 130 at administrator computer system 120. The indication indicates that one or more of the applications 111 pre-installed on the data image 110 are to be installed on the client computer system 101. The schedule manager 119 on the client computer system will determine that the administrator has changed settings indicating which applications are to be installed on the client computer system. Any changes in state will be applied to the client computer system. The applications will be installed from the data image based on which applications are to be installed for the specific user that is logged in to the client computer system. Accordingly, in cases where the administrator indicates that multiple applications are to be installed, one user might have certain applications installed, while another user has different applications installed.

The administrator may have a large amount of flexibility in specifying which applications are installed on which computer systems. For example, the administrator may specify that an application is to be installed for a specific user, for a specific computer system, or for a specific group of users. The administrator 130 can similarly remove or modify applications that are installed on a computer system for that computer, or just for specific users or groups of users. Those applications that are to be installed can be done so substantially immediately, as the applications (or at least portions thereof) are already pre-installed on the data image 110. The administrator may be able to further specify, for each application, whether the client's desktop display is to be displayed while that application is being installed at login. Thus, when the user logs in and the pre-installed applications are to be installed, the administrator may specify whether the client's normal desktop user interface is to be displayed, or whether it should not be displayed until after installation of the application. In this manner, the administrator can control the user's experience as he or she logs in to the client computer system.

Method 200 includes an act of publishing a notification to the client computer system indicating that a specified software application pre-installed on the client computer system's data image is to be installed, wherein upon receiving the notification, the software application is installed on the client computer system from the data image (act 230). Thus, notification 126 may be published by administrator computer system 120. The notification may be sent to multiple different client computer systems, including client computer system 101. The notification 126 indicates which of the pre-installed applications 111 on data image 110 is to be installed on the client computer systems.

In some cases, the software application is installed on the client computer system according to a per-user scheduler. In such cases, the schedule manager 119 may indicate to a per-user scheduler that the application is to be installed based on a pre-defined schedule (e.g. the application is to be installed when the user logs in, or at a certain time of day). As such, the application may be installed (e.g. by application installer 115) based on a schedule, without communicating with another computer system over a computer network. Once the application 116 is installed on the client computer system, the application may be customized according to various user-specified settings. These settings may be stored in a data store on the client computer system or in a network-accessible data store. The settings may be applied to the application after it is installed from the image.

In some cases, the pre-installed application may be installed to the client computer system very quickly, and the customizations 118 may be applied as the application is being installed. The application may be installed at user login, or while the user is already logged in. In such cases, the application is installed (or modified or uninstalled) seamlessly, without any requirement for user interaction. The installed software application is not customized in cases where the per-user scheduler determines that settings in the data store have not changed since the user's last login. Accordingly, if the per-user scheduler determines that no customization or application settings have changed since the last time the user used the application, no customization will occur.

Whenever an application has been installed, updated or removed from the client computer system, the data store may be updated. Accordingly, the schedule manager 119 may apprised of any changes to the applications on the client computer system by checking for the changes in the data store. Any software applications installed may be registered for the specific user that is logged on. Accordingly, based on user 105's login credentials 106, the client computer system may use registration information 117 to register the applications that were installed or updated upon receiving the notification 126 from the administrator. In some cases, the registering may be performed on the client computer system without communicating over a computer network, either to the administrator computer system 120 or to another computer system.

Software applications installed from the data image 110 (or otherwise installed) may be automatically and transparently updated while the user 105 is logged in to the client computer system. The updates may occur seamlessly and without any requirement for user interaction. In some cases, the user may not even be aware that the application is being updated. Similarly, applications may be installed, removed or otherwise modified in this seamless and transparent manner. These installations, modifications, updates or application removals may occur while the user is logged in, during the user's login session. If the computer system determines that a failure has occurred during the installation of the software application, the installation is retried a specified number of times. This specified number of installation retries may be provided by the administrator 130.

In some cases, an application specified for installation by the administrator may already be installed on the client computer system 101. In such cases, the software application may be automatically and transparently registered for the user logged in to the client computer system. Furthermore, any user-specific customizations may be applied to the previously installed application. Thus, an application may be provisioned and updated transparently and seamlessly while the user is logged in to the computer system.

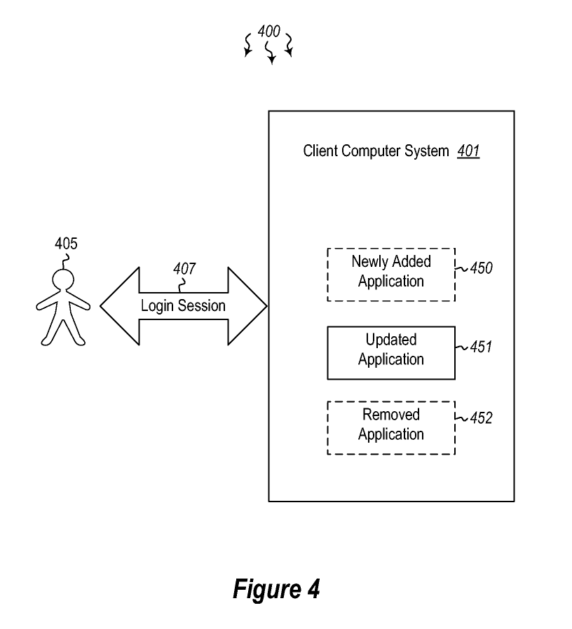

FIG. 3 illustrates a flowchart of an alternative method 300 for efficiently provisioning applications in a multi-user environment. The method 300 will now be described with frequent reference to the components and data of environments 100 and 400 of FIGS. 1 and 4, respectively.

Method 300 includes an act of accessing a data image that includes one or more preinstalled software applications (act 310). For example, client computer system 101 may access pre-installed applications 111 in data image 110. Application installer 115 may install the software applications identified by the administrator 130 for installation on the client computer system (act 320). Client computer system 101 may receive login credentials 106 before or during the installation of the application(s) (act 330). The login credentials may be used to log the user in, and further identify to the per-user scheduler which customization settings and or registration information are to be applied to the installed applications.

Method 300 further includes, based on the user's login credentials, an act of applying user-specific software application registration information and customizations to one or more of the installed software applications (act 340). For example, registration information 117 and customizations 118 may be applied to one or more of the installed applications based on the identity of the user. If a second, different user logs in to the client computer system 101, one or more of the installed software applications may be customized for the second user. While the second user is logged in, applications may be updated, installed or removed seamlessly and transparently, just as with the first user.

For example, as shown in FIG. 4, a first, second or other user 405 may login to client computer system 401. During the established login session 407, an application may be added to the computer system (e.g. newly added application 450). This application (or another application) may be updated (e.g. updated application 451) or removed (e.g. removed application 452) seamlessly and transparently while the user is logged in. The updating, installing and/or removal may be initiated at the request of the administrator 130. Once the administrator inputs the request 131, the notification publishing module 125 published notification 126 which is received by the client computer systems. Then, depending on which user is logged on to the client computer system at that time, the appropriate applications are installed, uninstalled or removed substantially immediately.

In cases where the user has uninstalled a certain application from the client computer system, the client computer system may prevent the application from being reinstalled when the user logs in. In some cases, if one user uninstalls an application, that software application's binary files may not be removed from the client computer system. In this manner, the application is available for registration and customization by other users of the client computer system. Accordingly, methods, systems and computer program products are provided which efficiently provision applications in a multi-user environment.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. At a server computer system including at least one processor and a memory, a computer-implemented method for efficiently provisioning applications in a multi-user environment, the method comprising:
an act of pre-installing at least a portion of a software application on a data image, wherein the software application is to be installed on a client computer system upon receiving a notification from a computer administrator;
an act of receiving an input from the computer administrator indicating that a specified software application pre-installed on the client computer system's data image is to be installed on the client computer system; and
an act of publishing a notification to the client computer system indicating that a specified software application pre-installed on the client computer system's data image is to be installed, wherein upon receiving the notification, the software application is installed on the client computer system from the data image.

2. The method of claim 1, wherein the software application is installed on the client computer system according to a per-user scheduler, without communicating with another computer system over a computer network.

3. The method of claim 1, further comprising customizing the installed application according to one or more user-specified settings stored in a data store.

4. The method of claim 3, wherein the installed software application is not customized if the per-user scheduler determines that settings in the data store have not changed since the user's last login.

5. The method of claim 3, further comprising updating the data store upon determining that a software application has been installed, updated or removed from the client computer system.

6. The method of claim 1, further comprising registering the software application for a specific user on the client computer system without communicating over a computer network.

7. The method of claim 1, wherein the software application is automatically and transparently updated while a user is currently logged in to the client computer system.

8. The method of claim 1, wherein a new software application is transparently installed while a user is currently logged in to the client computer system.

9. The method of claim 1, wherein at least one software application is transparently removed while a user is currently logged in to the client computer system.

10. The method of claim 1, wherein one or more software applications are provisioned onto an offline data image.

11. The method of claim 1, wherein the computer administrator specifies, for each application, whether the client desktop display is to be displayed while that application is being installed at login.

12. The method of claim 1, wherein upon determining that a failure has occurred during the installation of the software application, the installation is retried a specified number of times.

13. The method of claim 1, wherein if the software application specified by the computer administrator is already installed on the client computer system, the software application is automatically and transparently registered for the user logged in to the client computer system.

14. At a client computer system including at least one processor and a memory, a computer-implemented method for efficiently provisioning applications in a multi-user environment, the method comprising:
an act of accessing a data image that includes one or more preinstalled software applications;
an act of installing on the client computer system those software applications that are preinstalled in the data image;
an act of receiving at the client computer system login credentials from a user logging in to the client computer system; and
based on the user's login credentials, an act of applying user-specific software application registration information and customizations to one or more of the installed software applications.

15. The method of claim 14, wherein a second, different user logs in to the computer system and at least one of the software applications are customized for the second, different user.

16. The method of claim 14, wherein at least one of the software applications is dynamically updated while the while user is currently logged in.

17. The method of claim 14, further comprising:
determining that the user has uninstalled a specified software application from the client computer system; and
preventing the client computer system from reinstalling the application upon user login.

18. The method of claim 14, wherein if a first user uninstalls a software application, that software application's binary files are not removed, such that the software application is available for registration and customization by other users of the client computer system.

19. A computer system comprising the following:
one or more processors;
system memory;
one or more computer-readable storage media having stored thereon computer-executable instructions that, when executed by the one or more processors, causes the computing system to perform a method for efficiently provisioning applications in a multi-user environment, the method comprising the following:
an act of pre-installing at least a portion of a software application on a data image, wherein the software application is to be installed on a client computer system upon receiving a notification from a computer administrator;
an act of receiving an input from the computer administrator indicating that a specified software application pre-installed on the client computer system's data image is to be installed on the client computer system;
an act of publishing a notification to the client computer system indicating that a specified software application pre-installed on the client computer system's data image is to be installed, wherein upon receiving the notification, the software application is installed on the client computer system from the data image;
an act of installing the software application on the client computer system according to a per-user scheduler, without communicating with another computer system over a computer network; and
an act of customizing the installed application according to one or more user-specified settings stored in a data store.

20. The computer system of claim 19, further comprising updating the data store upon determining that a software application has been installed, updated or removed from the client computer system.
